(19) United States
(12) Patent Application Publication
(10) Pub. No.: US 2005/0033952 A1
(43) Pub. Date: Feb. 10, 2005

(54) Dynamic scheduling of diagnostic tests to be performed during a system boot process

(75) Inventor: Wayne A. Britson, Rochester, MN (US)

Correspondence Address: Leslie J. Payne;IBM Corporation, Dept. 917, 3605 Highway 52 North, Rochester, MN, 55901-7829, US

(73) Assignee: International Business Machines Corporation, Armonk, NY (US)

(21) Appl. No.: 10/636,061

(22) Filed: Aug. 7, 2003

(51) Int. Cl. G06F 15/177

(52) U.S. Cl. 713/2

(57) ABSTRACT

A method, system, and article of manufacture for automatically performing one or more diagnostic tests during a system boot process are provided. The tests may be performed after a specific period or periods of time associated with the tests have passed since the tests were last performed. Such periodic diagnostic tests may allow faulty chips or other problems within the system to be detected before the occurrence of full system failures that could cause unacceptable downtime.

### BACKGROUND OF THE INVENTION

1. Field of the Invention

The present invention generally relates to a method and system for booting computer systems and more particularly to a method and system for periodically performing extended hardware diagnostic tests during a boot process in a logically partitioned computer system.

2. Description of the Related Art

In a computing environment, the term initial program load (IPL) generally refers to the process of taking a system from a powered-off or non-running state to the point of loading operating system specific code. This process could include running various tests, commonly referred to as System Power On Self Tests (POST), on various components. In a multi-processor system all functioning processors would go through the IPL process, which may require a significant amount of time.

In prior art, speed and availability of resources after an IPL was achieved by curtailing or removing POST and/or performing POST only after a system failure was detected. The resulting process in which exhausting tests on the system hardware are skipped is commonly referred to as a FAST IPL. In a SLOW IPL, however, all the hardware diagnostics are performed, resulting in a slower IPL time but better chance of error detection and prevention of related system failures. Performing a SLOW IPL or extended diagnostics for large complex server systems increases the boot time typically by a factor of three to four times in a normal day-to-day user environment, which is often unacceptable. However, skipping POST and performing a FAST IPL only, compromises system integrity. If the system develops a problem, the end user may not be aware of it until the failing part is used, or after damage is done to the user's data.

In order to speed the IPL process, some systems dynamically select between a FAST and a SLOW IPL. These systems typically perform a SLOW IPL (with POST) only when some condition such as a system failure occurs. A system failure or a non-recoverable error of a processor in a multi-processor system is a catastrophic event that leads to a check-stop condition in which all processors in the system are stopped, and an IPL is performed. However, processors running in a multi-processor system (as well as other components) may also experience errors that are considered recoverable. An error is classified as recoverable if the error can be corrected with no loss of data. These recoverable errors will typically not prompt a SLOW IPL, but may be predictive of failure, such as a faulty chip in the system. A periodic SLOW IPL may be able to detect recoverable errors or faulty chips that have not yet created a failure. By detecting and isolating faulty chips that may exist in the system, the downtime that results from a system failure may be avoided.

Accordingly there is a need for an improved method and system for periodically performing extended diagnostic tests during a boot process (e.g., a SLOW IPL), for example, in an effort to detect any faulty chips or problems that may exist within a system before they cause a system failure.

### SUMMARY OF THE INVENTION

The present invention generally is directed to a method, article of manufacture, and system for performing an automatic extended diagnostics test during a system boot process.

One embodiment provides a method for periodically performing extended diagnostic testing during a system boot process. The method generally includes determining when extended diagnostic testing was last performed on the computer system and, in response to determining extended diagnostic testing has not been performed within a predefined time period, performing extended diagnostic testing on the computer system.

Another embodiment provides a method for performing specific extended diagnostic tests during a system boot process. The method generally includes determining, for each of a set of one or more diagnostic tests, when the diagnostic tests were last performed, and in response to determining any selected one of the diagnostic tests has not been performed within a corresponding specified period of time, performing the selected diagnostic test.

Another embodiment provides a computer-readable medium containing a program for performing a system boot process. The method generally includes determining when one or more diagnostic tests were last performed, and in response to determining the one or more of diagnostic tests have not been performed within one or more corresponding time periods, performing the one or more diagnostic tests.

Another embodiment provides a multi-processor computer system comprising a plurality of hardware components and a service processor configured to boot the system, and during a boot process, perform one or more diagnostic tests on the hardware components, in response to determining the one or more diagnostic tests have not been performed within one or more corresponding time periods.

### BRIEF DESCRIPTION OF THE DRAWINGS

So that the manner in which the above recited features, advantages and objects of the present invention are attained and can be understood in detail, a more particular description of the invention, briefly summarized above, may be had by reference to the embodiments thereof which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a system block diagram of a multi-processing system illustratively utilized in accordance with the invention.

FIG. 2 is a flow chart illustrating exemplary operations for dynamically selecting a system boot process that may be performed in accordance with an embodiment of the present invention.

FIG. 3 is a flow chart illustrating exemplary operations for selectively performing specific diagnostic tests during a system boot process in accordance with an embodiment of the present invention.

FIGS. 4A-4C. illustrate exemplary graphical user-interface (GUI) screens that may be presented to a user in accordance with embodiments of the present invention.

### DETAILED DESCRIPTION OF THE PREFERRED EMBODIMENTS

The present invention generally is directed to a method, system, and article of manufacture for automatically performing one or more diagnostic tests during a system boot process. In contrast to the prior art, the tests may be performed not only after a system failure has occurred but also after a specific period of time has passed since the last extended diagnostics. Thus, faulty chips or other problems within the system may be detected before occurrence of full system failures that could cause unacceptable downtime. Performing extended diagnostics periodically help in preventing system failures and maintaining system integrity.

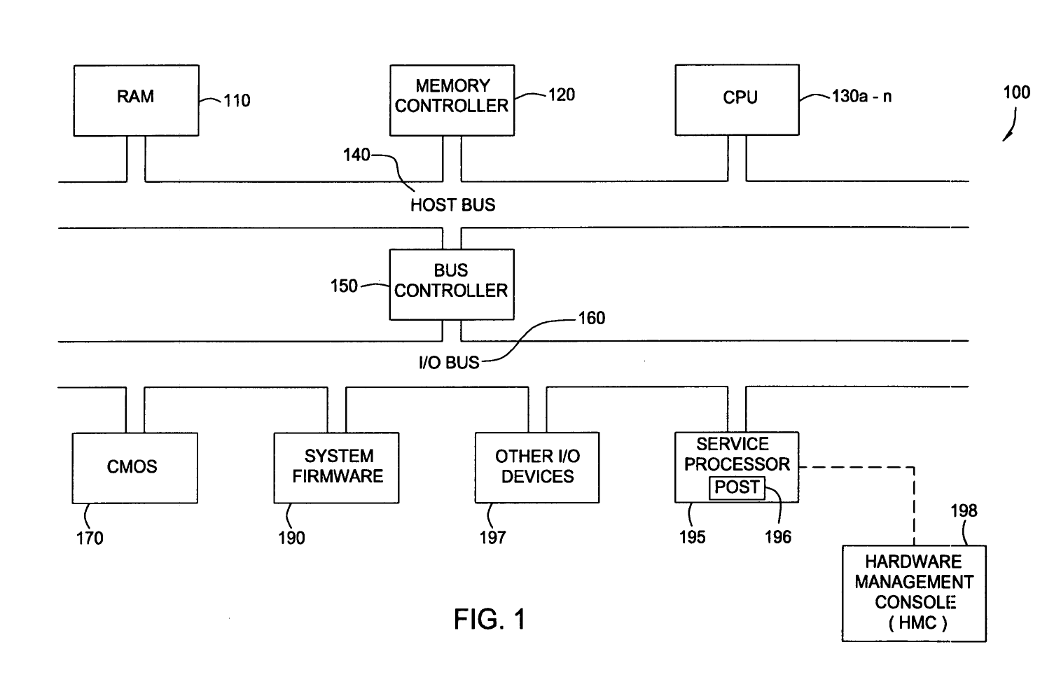

One embodiment of the invention is implemented as a program product for use with a computer system such as, for example, the multi-processor computer system 100 shown in FIG. 1 and described below. The program(s) of the program product defines functions of the embodiments (including the methods described herein) and can be contained on a variety of signal-bearing media. Illustrative signal-bearing media include, but are not limited to: (i) information permanently stored on non-writable storage media (e.g., read-only memory devices within a computer such as CD-ROM disks readable by a CD-ROM drive); (ii) alterable information stored on writable storage media (e.g., floppy disks within a diskette drive or hard-disk drive); and (iii) information conveyed to a computer by a communications medium, such as through a computer or telephone network, including wireless communications. The latter embodiment specifically includes information downloaded from the Internet and other networks. Such signal-bearing media, when carrying computer-readable instructions that direct the functions of the present invention, represent embodiments of the present invention.

In general, the routines executed to implement the embodiments of the invention, may be part of an operating system or a specific application, component, program, module, object, or sequence of instructions. The computer program of the present invention typically is comprised of a multitude of instructions that will be translated by the native computer into a machine-readable format and hence executable instructions. Also, programs are comprised of variables and data structures that either reside locally to the program or are found in memory or on storage devices. In addition, various programs described hereinafter may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

FIG. 1 illustrates a system block diagram of a typical symmetrical multi-processing system 100 utilized in accordance with embodiments of the present invention. While various system components are shown, it should be noted that a typical computer system contains many other components not shown, which are not essential to an understanding of the present invention. In one embodiment, the system 100 is an eServer iSeries computer system available from International Business Machines (IBM) of Armonk, N.Y., however, embodiment of the present invention may be implemented on other multiprocessor computer systems, as well as single processor computer systems.

In general, a first set of multiple central processing units (CPUs) 130a to 130n (collectively, CPUs 130) are connected to system RAM via a memory controller 120 and host bus 140. The CPUs 130 are further connected to other hardware devices via host bus 140, bus controller 150, and I/O bus 160. These other hardware devices may include, for example, a nonvolatile storage device, such as CMOS 170, system firmware Read-Only Memory (ROM) 190, a Service Processor 195, as well as other I/O devices 197, such as a keyboard, display, mouse, joystick, or the like.

For some embodiments, the machine executed method of the present invention may be performed by the service processor 195, possibly in conjunction with a hardware management Console (HMC) 198. The service processor 195 typically comprises a built-in microcontroller used to perform general management functions, such as IPLs, in a symmetrical multi-processing or server system. An actual implementation of such a service processor might be used on IBM server based microprocessors, or on other suitable processor-based computer systems. Besides assisting the server system during initial program load (IPL) by connecting the HMC to the computer system, its primary responsibility is to monitor the heath of the server system. If the system fails (due to hardware or software fault), the service processor 195 is able to detect the conditions and take actions like attempt reboot recovery or send diagnostic messages to a technician to report the problem. It should be understood that the service processor 195 on IBM based servers does not run the native operating system (ATX, NT, etc), but instead uses its own operating environment. Additionally, the service processor 195 typically operates on Standby Power and is therefore “alive” even when the system is powered off. This allows the service processor 195 to support remote operations especially useful to perform remote diagnostics.

For some embodiments, the service processor 195 may be configured to dynamically schedule one or more diagnostic tests to be performed during a boot process, based on one or more test periods specified, for example, by an administrator via the HMC 198. The HMC 198 is generally configured to provide a user (e.g., an administrator) with an interface to the system 100, via communication with the service processor 195. For some embodiments, the HMC 198 may be implemented as a custom configured personal computer (PC) connected to the computer system 100 (using the service processor 195 as an interface) and used to configure system management functions, such as scheduling diagnostic testing to be performed during IPLs. For some embodiments, similar functionality may be provided via one or more other types of interfaces, for example, via a service partition (not shown), or other similar type interfaces, that may also interface with the service processor 195.

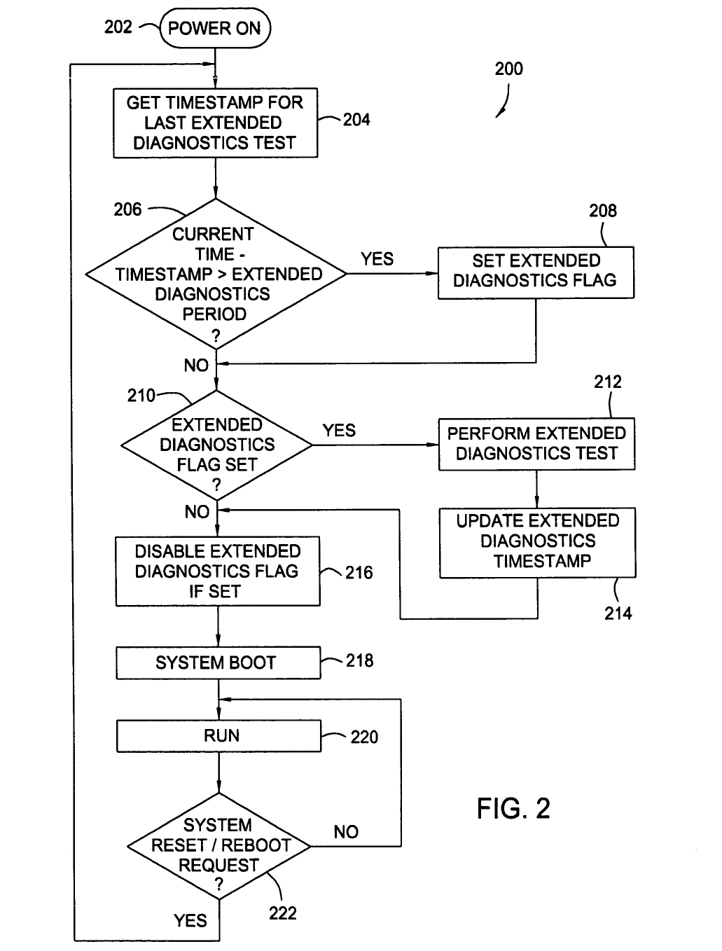

FIG. 2 illustrates a method for dynamically selecting whether or not to perform an extended diagnostics test during a boot process. These operations may be performed by the service processor 195. The operations 200 begin at step 202, by entering a boot process, for example, as the result of either a system power on or a reboot request (e.g., a user request or a system failure). At step 204, the service processor 195 obtains the timestamp for the last extended diagnostics test which may be located in a register in memory. In a preferred embodiment of the present invention this timestamp is stored in non-volatile memory such as CMOS 170, so it persists across power cycles. At step 206 the service processor 195 compares the time difference between the current date and the timestamp, to the system specified extended diagnostics period to check whether the time difference exceeds the allowable period. If the time difference exceeds the allowable predefined period, the system then enables the extended diagnostics flag in step 208. This flag may also be located in a register in non-volatile memory.

At step 210, the service processor 195 checks to see if the flag is enabled. When the diagnostics flag is set, the service processor 195 performs extended diagnostic tests on hardware, as shown in step 212. As will be described in greater detail below, for some embodiments, a user may be notified (e.g., via the HMC 198) when extended diagnostic tests are being performed and/or may be given the option of skipping the diagnostic tests.

Extended diagnostic tests generally involve a full system boot of all the hardware in the computer system 100. After performing the diagnostics test, the service processor 195 then updates the extended diagnostics timestamp with the current time in step 216 and goes to step 214, wherein the extended diagnostics flag is disabled. The diagnostics flag is always disabled whether or not the flag was enabled so that the system boot will be presented with cleared registers when starting the boot process. The process then proceeds to step 218, and the system is booted with a normal boot routine absent the extended diagnostics testing. The system may then go through a period of normal run as shown in step 220 until a system reboot request is received in step 222. The system is then rebooted starting at step 204 and the process continues as described above. Of course, one skilled in the art will recognize that, rather than rely on a stored timestamp, other timing techniques may be utilized. For example, an active timer preset to the specified time period may be continuously decremented to zero. During a reboot process, extensive diagnostic tests may be performed if a test indicates the timer has expired. The active timer may be examined during a boot process or while running, possibly causing a reboot request.

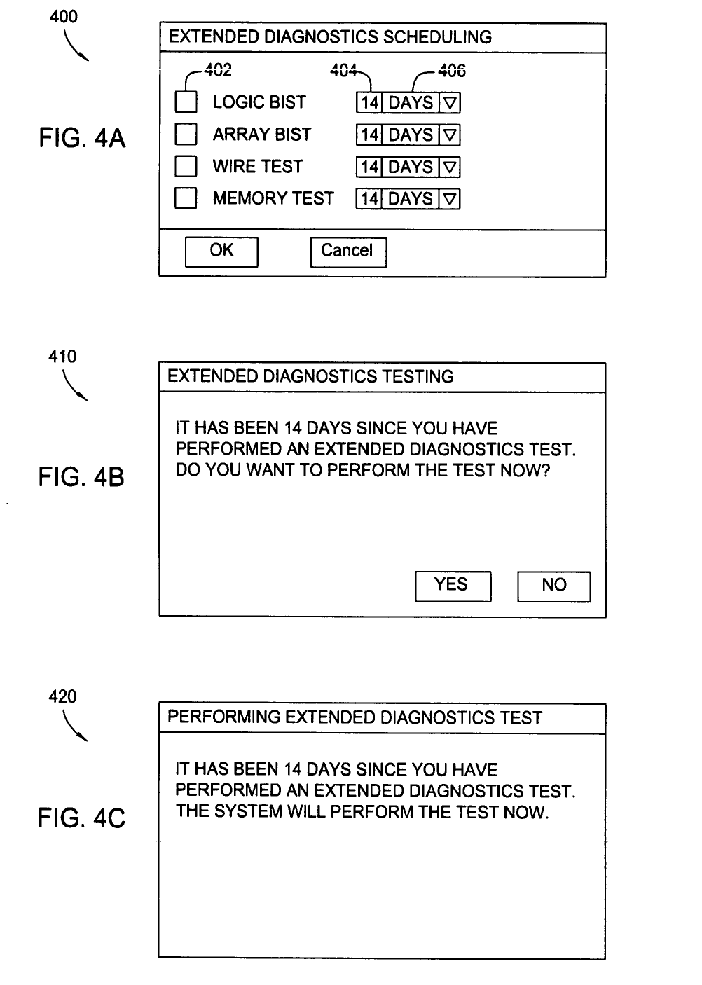

Extended diagnostics testing generally refers to extensive and relatively time consuming testing of at least most major hardware components in the system and may include, but is not limited to, logical built-in self test (logical BIST), array built-in self test (array BIST), network or “wire” testing, and exhaustive memory diagnostic testing. In a preferred embodiment of the present invention an administrator may be able to set different time periods for each of the different kinds of tests via a graphical user-interface (GUI) screen, as described below with reference to FIG. 4A. This may enable administrators to set shorter time periods for tests that are more essential for their systems and avoid performing a full system diagnostics which takes a longer time.

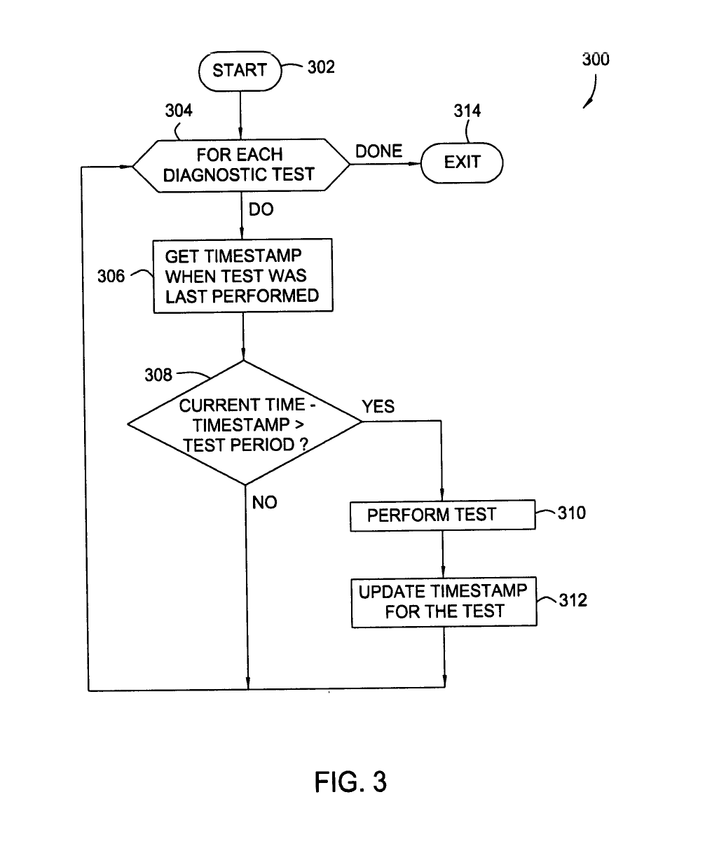

FIG. 3 is a flow diagram of exemplary operations 300 that may be performed to perform selective diagnostic tests, based on different specified periods. For example, for some embodiments, the operations 300 may be performed in place of operations 204-214 shown in FIG. 2. The operations 300 begin at step 302, for example, upon initiating a boot process. At step 304, for each diagnostics test, the service processor 195 obtains a timestamp indicating when the test was last performed in step 306. The system then compares the time difference between the current time and the timestamp with the specified period set for that test, as shown in step 308. If this difference exceeds the administrator specified time period, the system performs the test in step 310 and updates the test's timestamp as shown in step 312. When the difference does not exceed the time period specified, the system goes back to step 304 and continues as described above. As previously described, other timing techniques may also be used to determine whether or not any selected one of the diagnostic tests has been performed within a predefined time period (e.g., maintaining a free running counter). After the process is repeated for each diagnostics test, the system exits at step 314, for example, to return to a normal boot routine.

FIG. 4A shows an exemplary GUI screen 400 through which users (e.g., administrators) can customize their systems by setting different time periods for each diagnostics test. Of course, the diagnostic tests shown are exemplary only, and the exact tests may vary with different embodiments. As illustrated, the GUI screen 400 may have check boxes 402 allowing the user to select which diagnostic tests to run during a boot process, as well as edit boxes 404 and pull down menus 406 allowing the user to specify the corresponding test periods to accommodate their own system specific needs.

As previously described, for some embodiments, users may be given an option whether or not to perform extended testing. For example, when the system detects that the specific time period has been exceeded, it may present a user with a GUI screen, such as the dialog box 410 shown in FIG. 4B. As illustrated, the user may be notified that a specific number of days has passed since the last diagnostic testing was done and may be prompted to choose if they want to perform the test now or later. As an alternative, extended diagnostic tests may be performed automatically without user intervention. Because such test may be rather lengthy, however, the user may still be presented with a GUI screen informing them of the time period since the last test and of the automatic performance of the tests, such as the dialog box 420 shown in FIG. 4C.

While the foregoing is directed to embodiments of the present invention, other and further embodiments of the invention may be devised without departing from the basic scope thereof, and the scope thereof is determined by the claims that follow.

1. A method for booting a computer system comprising:
determining when extended diagnostic testing was last performed on the computer system; and
in response to determining extended diagnostic testing has not been performed within a predefined time period, performing extended diagnostic testing on the computer system.

2. The method of claim 1, wherein the determining comprises examining a timestamp indicative of when extended diagnostic testing was last performed on the computer system.

3. The method of claim 2, further comprising updating the timestamp with the current time after performing extended diagnostic testing.

4. The method of claim 1, wherein the determining comprises examining a free timer that is preset to the predefined time period upon performing extended diagnostic testing.

5. The method of claim 4, wherein extended diagnostic testing is performed when the timer expires.

6. The method of claim 1, further comprising generating a graphical user-interface screen indicating extended diagnostic testing has not been performed within a specified period of time.

7. The method of claim 6, wherein the graphical user-interface screen allows users to choose whether or not to perform extended diagnostic testing.

8. The method of claim 1, further comprising receiving the predefined time period from a user.

9. The method of claim 8, further comprising generating a graphical user-interface screen that allows a user to enter the predefined time period.

10. A method for booting a computer system, comprising:
determining, for each of a set of one or more diagnostic tests, when the diagnostic tests were last performed; and
in response to determining any selected one of the diagnostic tests has not been performed within a corresponding specified period of time, performing the selected diagnostic test.

11. The method of claim 10, further comprising receiving from a user an indication of the one or more diagnostic tests in the set.

12. The method of claim 11, further comprising receiving from the user specified periods of time corresponding to the diagnostic tests in the set.

13. The method of claim 10, wherein the determining comprises examining, for each diagnostic test in the set, a corresponding timestamp.

14. The method of claim 13, wherein the timestamp is indicative of when the corresponding diagnostic test was last performed.

15. A computer readable medium containing a program for performing a boot process for a computer system which, when executed by a processor, performs operations comprising:
determining when one or more diagnostic tests were last performed; and
in response to determining the one or more of diagnostic tests have not been performed within one or more corresponding time periods, performing the one or more diagnostic tests.

16. The computer readable medium of claim 15, wherein the operations further comprise providing an indication that the one or more diagnostic tests have not been performed within the one or more corresponding specified time periods.

17. The computer readable medium of claim 15, further comprising providing an interface allowing a user to specify the one or more corresponding time periods.

18. A multi-processing computer system, comprising:
a plurality of hardware components; and
a service processor configured to boot the system and, during a boot process, perform one or more diagnostic tests on the hardware components, in response to determining the one or more diagnostic tests have not been performed within one or more corresponding time periods.

19. The system of claim 18, further comprising a hardware management console in communication with the service processor.

20. The system of claim 19, wherein the hardware management console is configured to provide an indication that the one or more diagnostic tests have not been performed.

21. The system of claim 19, wherein the hardware management console is configured to provide a graphical user-interface screen allowing a user to specify periods of time associated with each of the one or more diagnostic tests.

22. The system of claim 21, wherein the one or more diagnostic tests comprise at least one Logical Built-in Self Test and at least one Array Built-in Self Test, and wherein the graphical user-interface screen allows a user to specify a different time period for each.
